(19) United States
(12) Patent Application Publication
(10) Pub. No.: US 2009/0327356 A1
(43) Pub. Date: Dec. 31, 2009

(54) METHOD AND SYSTEM FOR IMPROVED TRANSITION BETWEEN ALTERNATING INDIVIDUAL AND COMMON CHANNEL PROGRAMMING VIA SYNCHRONIZED PLAYISTS

(76) Inventors: Gregory Herlein, San Francisco, CA (US); David Wang, San Francisco, CA (US)

Correspondence Address: Robert D. Shedd, Patent Operations;THOMSON Licensing LLC, P.O. Box 5312, Princeton, NJ, 08543-5312, US

(21) Appl. No.: 12/448,869

(22) PCT Filed: Oct. 25, 2007
(86) PCT No.: PCT/US07/22602

§ 371 Date: Jul. 10, 2009

Related U.S. Application Data
(60) Provisional application No. 60/899,056, filed on Feb. 2, 2007.

(51) Int. Cl. G06F 17/30

(52) U.S. Cl. 707/201; 707/E17.005

(57) ABSTRACT

Embodiments of the present invention provide a method, apparatus and system for a synchronized playlist calculation, which is used to calculate playlists and filler media for seamless transitions during the alternation of individual and common channel programming. In various embodiments of the present invention, an optimum switching (synchronization) point is determined for the individual channels. Subsequently, channels not having a termination/end point consistent with the determined switching point are padded with respective filler content (media) to coordinate the termination points of the channels to be synchronized. The amount of filler content needed for each channel is determined respectively for a channel. Similarly, a switching (synchronization) point is determined for the common channel to provide accurate transitions.

### CROSS REFERENCE TO RELATED APPLICATIONS

This application claims the benefit of U.S. provisional patent application No. 60/899,056, filed Feb. 2, 2007, which is herein incorporated by reference in its entirety.

### FIELD OF THE INVENTION

The present invention generally relates to display control and programming and, more particularly, to a method, apparatus and system for providing improved transitions between alternating individual channel programming and common channel programming using synchronized playlists.

### BACKGROUND OF THE INVENTION

Information and content distribution systems are used to provide information and content to a plurality of end systems. Such systems are constantly evolving and the demand for improved performance is continually on the rise. For example, in video-on-demand applications media content has been made available to and utilized by satellite/cable television subscribers. Typically, subscribers can view at their television via a set-top box the video programs available for selection (sometimes for an additional fee) and upon selection made at the subscriber's set-top-box (STB), the program is sent from the program center to the set-top-box via the cable or satellite network. On occasion, in such video-on-demand systems, a single channel is communicated to all subscriber set-top boxes.

Similarly, in the advertising realm, providing in-store retail media content is becoming the most popular advertising medium in use today, with broadcast distribution being its primary means of content presentation. That is, in recent years retailers and the managers of public spaces have brought in video display systems for advertising use. In such systems, content is distributed by a server and received at a respective receiver, such as a set-top-box for each display or group of displays and a speaker for audio systems, typically in the form of playlists. Retailers use the displays and audio systems to present their current offerings or sale information in the form of respective playlists for each of the channels or groups of channels, while the public spaces sell time on the video displays to advertisers either national or local, knowing that large numbers of consumers will see the presentation.

In various content distribution systems as those described above, the playlists include programming for a single channel (e.g., a headline channel) to be communicated to all receivers at determined time periods for the purposes of communicating a synchronized message across all available channels. In such systems, switching receivers or displays at the correct time to a single common channel (e.g., a headline channel) provides a powerful tool for distribution and a powerful messaging medium for advertising. That is the advertising message is more effectively communicated with a synchronized approach where receivers, such as screens and speakers in an advertising environment, such as a store, can alternately show headline programming (in sync with all other screens and speakers) and department or local channel level programming. At appropriate points in the playlists, the receivers or displays must be able to alternate between headline programming and individual department/local channel programming. However, traditional store-wide and department TV channels are not as effective as desired. There are drawbacks to the currently available models for switching receivers to a single common channel. More specifically, in such applications, the effectiveness of the switch is diminished if the switching occurs at the wrong time, for example, in the middle of an advertisement. More specifically, if multiple channels are involved then the end point will not be at one point in time for all channels. This would result in one or more channels being cut off at the switching point. That is, current channel switching approaches are unable to support seamless transitions between alternating department/local channel and headline programming.

### SUMMARY OF THE INVENTION

Embodiments of the present invention address the deficiencies of the prior art by providing a method; apparatus and system for providing improved transitions between alternating individual channel programming and common channel programming using synchronized playlists.

In various embodiments of the present invention, applications are provided that provide a synchronized playlist calculation, which are used to calculate playlists and filler media for seamless transitions during the alternation of individual and common channel programming.

In one embodiment of the present invention, the optimum switching (synchronization) point is determined. Subsequently, channels not having a termination/end point consistent with the determined switching point are padded with respective filler content (media) to coordinate the termination points of the channels to be synchronized. The amount of filler content needed for each channel is determined respectively for a channel.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising in accordance with an embodiment of the present invention;

FIG. 3 depicts a flow diagram of a method for a Synchronized Playlist Calculation including the determination of a Real Synchronization Point for the transition from a headline channel into respective local channels in accordance with an embodiment of the present invention;

FIG. 4 depicts a flow diagram of a method for a Synchronized Playlist Calculation including the determination of a Real Synchronization Point for the transition from respective local channels to a headline channel in accordance with an embodiment of the present invention;

FIG. 5 depicts a flow diagram of a method for a Synchronized Playlist Calculation including the determination of a Real Synchronization Point for the transition from respective local channels to a headline channel in accordance with an alternate embodiment of the present invention;

FIG. 6 depicts a flow diagram of a method for a Synchronized Playlist Calculation including the determination of a Real Synchronization Point for the transition from respective local channels to a headline channel in accordance with yet an alternate embodiment of the present invention;

FIG. 7a depicts an example of synchronization parameters for a Synchronized Playlist Calculation in accordance with an embodiment of the present invention;

FIG. 7b depicts a table of channel playlist definitions for the Synchronized Playlist Calculation example of FIG. 6a in accordance with an embodiment of the present invention;

FIG. 7c depicts an example of a Synchronized Playlist Calculation for local channels in accordance with an embodiment of the present invention;

FIG. 7d depicts an example of a Synchronized Playlist Calculation for a headline channel in accordance with an embodiment of the present invention;

FIG. 7e depicts an example of a Synchronized Playlist Calculation for a second transition to local channels in accordance with an embodiment of the present invention in accordance with an embodiment of the present invention;

FIG. 7f depicts an example of a Synchronized Playlist Calculation for a second transition to a headline channel in accordance with an embodiment of the present invention; and

FIG. 8 depicts an example of a Synchronized Playlist Calculation for local channels in accordance with an alternate embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system providing improved transitions between alternating individual channel programming and common channel programming using synchronized playlists. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any content distribution and playback network such as a video on demand network and the like.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

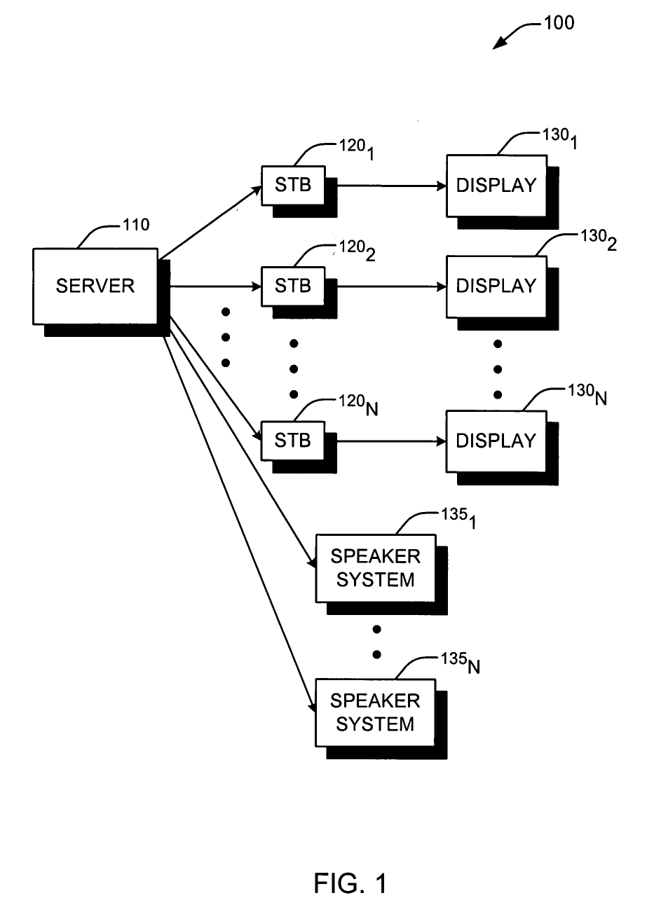

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

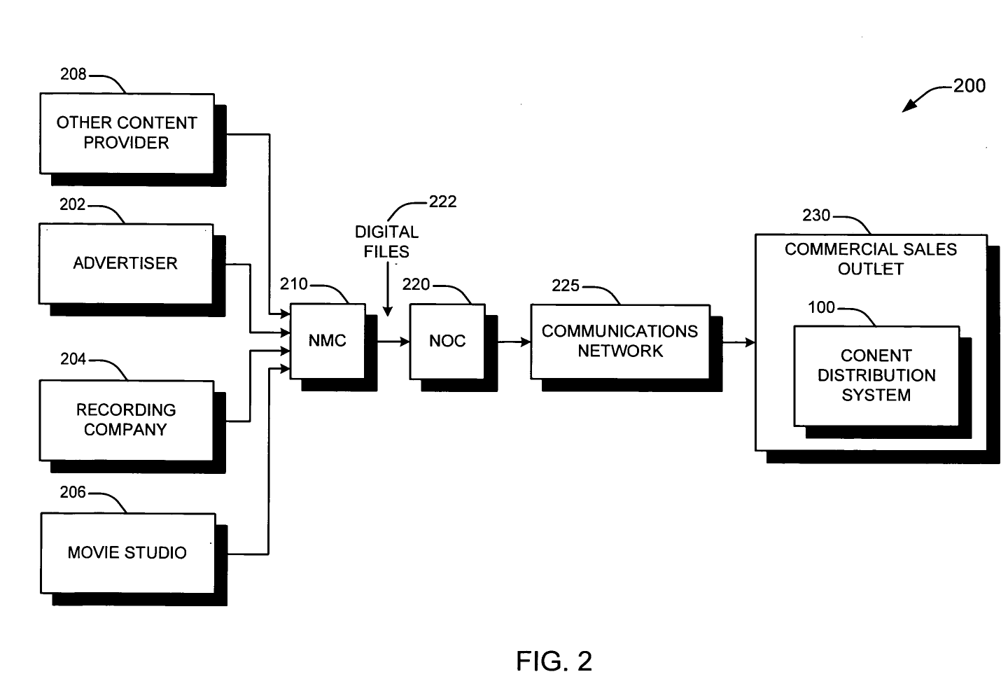

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130 and the speaker systems 135. That is in one embodiment of the present invention, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

In various embodiments of the present invention, the various streams can be organized in the form of playlists to be communicated to the various receivers throughout the store and displayed on specific displays in a predetermined order and frequency. That is, embodiments of the present invention provide a method, apparatus and system including a calculation of synchronized playlists [Synchronized Playlists Calculation (SPC)] and determination of filler media needed for seamless transitions during the alternation of local and headline programming across a plurality of content channels. It should be noted that the terms local and individual channel are to be considered interchangeable throughout the teachings of this disclosure.

The synchronization of the present invention can be determined or calculated at a remote server, such as the NMC 210 or the NOC 220, or at a local server such as the server 110 of the content distribution system 100 of FIG. 1. In addition, the synchronization of the present invention can be determined or calculated using a separate controller, similar to a general purpose computer or server, provided for performing the inventive concepts of the present invention. In various embodiments of the present invention, a controller or server contains information regarding individual channel content and common channel content for performing the various inventive aspects of the present invention. More specifically, in various embodiments of the present invention, a controller or server contains information regarding the respective playlists for each individual channel and common channel(s), such as individual media clip lengths, media clip durations for each of the individual channels and the common channel, desired durations for the respective individual channel playlists and the common channel, for performing the various inventive aspects of the present invention.

In accordance with an embodiment of the present invention, initially a synchronization point is determined. A synchronization point is a point in time which marks a transition between local and headline programming. In one embodiment, two types of Synchronization points are defined; an Ideal Synchronization point and a Real Synchronization point. An Ideal Synchronization Point is the ideal point in time at which a transition between department and headline programming should take place and vice versa. For example, headline programming should play for exactly an amount of time equal to the headline duration, at which point the programming should transition into local programming.

A Real Synchronization Point is the real point in time at which a transition between department and headline programming takes place and vice versa. Due to the fact that media files are of arbitrary length, the SPC must calculate a Real Synchronization Point as close to the Ideal Synchronization Point as possible, depending on the arbitrary lengths of the media files. For making this determination, the duration of the various programming channels must be taken into account.

For example, a Headline duration defines a length of time that the headline channel will play before a transition to department programming. A local channel duration defines a length of time that respective local channels will play, before a transition to headline programming. Filler media is a media which is used to pad a programming channel (View) until the length of the View approaches the Real Synchronization Point.

As previously described, a goal of an SPC of an embodiment of the present invention is to calculate and select a Real Synchronization Point which is closest in time proximity to the Ideal Synchronization Point, regardless if the calculated value falls before or after the Ideal Synchronization Point. For purposes of the calculation and in one embodiment of the present invention, the inventors consider a playlist for a particular channel a sequential loop. In addition, when building a View for a particular channel, the next media to be added to a View is considered the last recently added media file in the playlist. Even further, the inventors consider that the View length across all department channels for a given time period must be the same because all department channels are synchronized to transition to the headline channel at the same time.

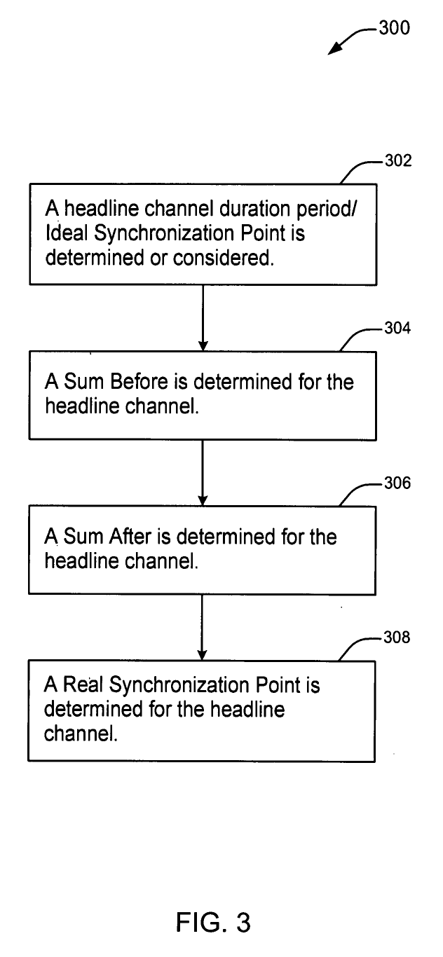

As such, to determine a Real Synchronization Point for the transition of the headline channel into respective local channels, method 300 of FIG. 3 can be performed for each channel. That is, FIG. 3 depicts a flow diagram of a method for Synchronized Playlist Calculation including the determination of a Real Synchronization Point for the transition of the headline channel into respective local channels. The method 300 begins at step 302 in which a headline duration period and as such, an Ideal Synchronization Point is determined or considered. The method 300 then proceeds to step 304.

At step 304, a Sum Before is determined. More specifically, for the headline duration period, a total number of headline media files (sequentially added from a headline playlist) that can fit within the headline duration period, without exceeding the time of the headline duration, are compiled. The method 300 then proceeds to step 306.

At step 306, a Sum After is determined. More specifically, a total number of headline media files (sequentially added from a headline playlist) that can fit within the headline duration period, until the first instance that the headline duration period is exceeded by a media file, are compiled. The method 300 then proceeds to step 308.

At step 308, a Real Synchronization Point is determined. That is, the Real Synchronization point is chosen by selecting either the Sum Before list of headline media files or the Sum After list of headline media files depending on which list of media files falls closest to the Ideal Synchronization Point. If the time deltas are equal, then in one embodiment of the present invention, the Sum Before is chosen. As such, the Real Synchronization Point is considered the end point in time or the synchronization point for system programming to transition from the headline channel back into respective local channels.

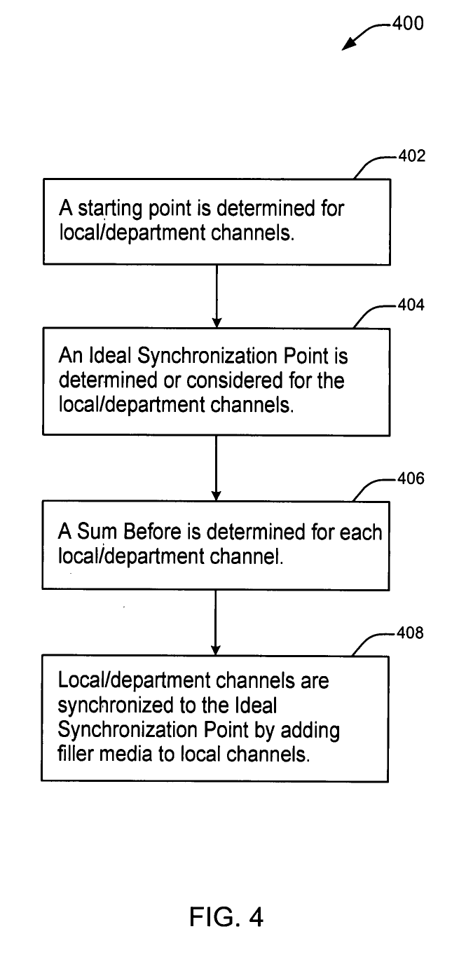

Similarly, to determine a Real Synchronization Point for the transition from respective local channels to a headline channel, method 400 of FIG. 4 can be performed for each channel. That is, FIG. 4 depicts a flow diagram of a method for a Synchronized Playlist Calculation including the determination of a Real Synchronization Point for the transition from respective local channels to a headline channel in accordance with an embodiment of the present invention. The method 400 begins at step 402 in which a starting point is determined or considered. That is, in various embodiments of the present invention, the starting point of the content for a local channel can be the determined Real Synchronization point for the headline channel. More specifically, when the duration of a headline channel expires, the programming of the local channels returns to displaying the respective regularly programmed content. In alternate embodiments of the present invention, a starting point can be the initial starting point of the programming for a specific period. That is, a starting point can comprise the first run of programming for a channel. The method 400 then proceeds to step 404.

At step 404, an Ideal Synchronization Point is determined or considered. That is, in one embodiment of the present invention at step 404 the start time of the next Headline event is considered as the Ideal Synchronization Point. The method 400 then proceeds to step 406.

At step 406, a Sum Before is determined for each local channel. More specifically, for each local channel a total number of media files (sequentially added from a local channel playlist) that can fit without exceeding the Ideal Synchronization Point are compiled. That is, the view for each channel is initially created with as many channel respective media files as possible, without exceeding the time until the Ideal Synchronization Point. As such, a Real Synchronization Point is determined for each channel. The method 400 then proceeds to step 408.

At step 408, the respective local channels are synchronized by adding a respective amount of filler media to each of the local channels to extend the media content of each of the local channels from the position of the respective Real Synchronization Points for each channel to the Ideal Synchronization Point. That is, at step 408, the views of each channel are extended to the Ideal Synchronization Point in order to synchronize the channels.

In accordance with the present invention, filler material can include video content in the form of advertisements, store announcement, and the like. In addition, filler material can be provided in substantially any length for extending channel content to synchronize channel views.

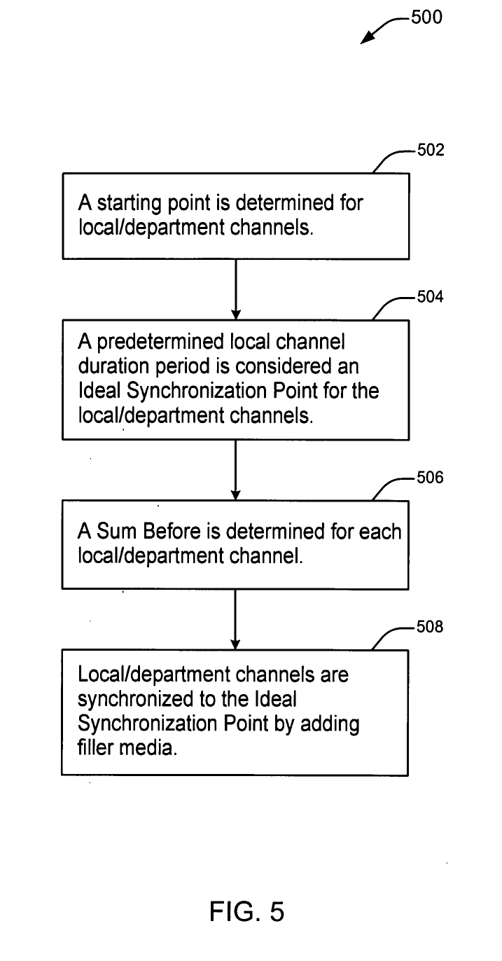

FIG. 5 depicts a flow diagram of a method for a Synchronized Playlist Calculation including the determination of a Real Synchronization Point for the transition from respective local channels to a headline channel in accordance with an alternate embodiment of the present invention. In the method 500 of FIG. 5, it is considered that an ideal duration time for the respective local channels is predetermined. The method 500 begins at step 502 in which a starting point is determined or considered. That is, in various embodiments of the present invention, the starting point of the content for a local channel can be the determined Real Synchronization point for the headline channel. More specifically, when the duration of a headline channel expires, the programming of the local channels returns to displaying the respective regularly programmed content from the playlists. In alternate embodiments of the present invention, a starting point can be the initial starting point of the programming for a specific period. That is, a starting point can comprise the first run of programming for the channels. The method 500 then proceeds to step 504.

At step 504, the predetermined local channel duration period is considered as the Ideal Synchronization Point. The method 500 then proceeds to step 506.

At step 506, a Sum Before is determined for each local channel. More specifically, for each local channel a total number of media files (sequentially added from a local channel playlist) that can fit without exceeding the Ideal Synchronization Point are compiled. That is, the view for each channel is initially created with as many channel respective media files as possible, without exceeding the time until the Ideal Synchronization Point. As such, a Real Synchronization Point is determined for each channel. The method 500 then proceeds to step 508.

At step 508, the respective local channels are synchronized by adding a respective amount of filler media to each of the local channels to extend the media content end point of each of the local channels from the position of the respective Real Synchronization Points for each local channel to the Ideal Synchronization Point. That is, at step 508, the views of each channel are extended to the Ideal Synchronization Point in order to synchronize the local channels.

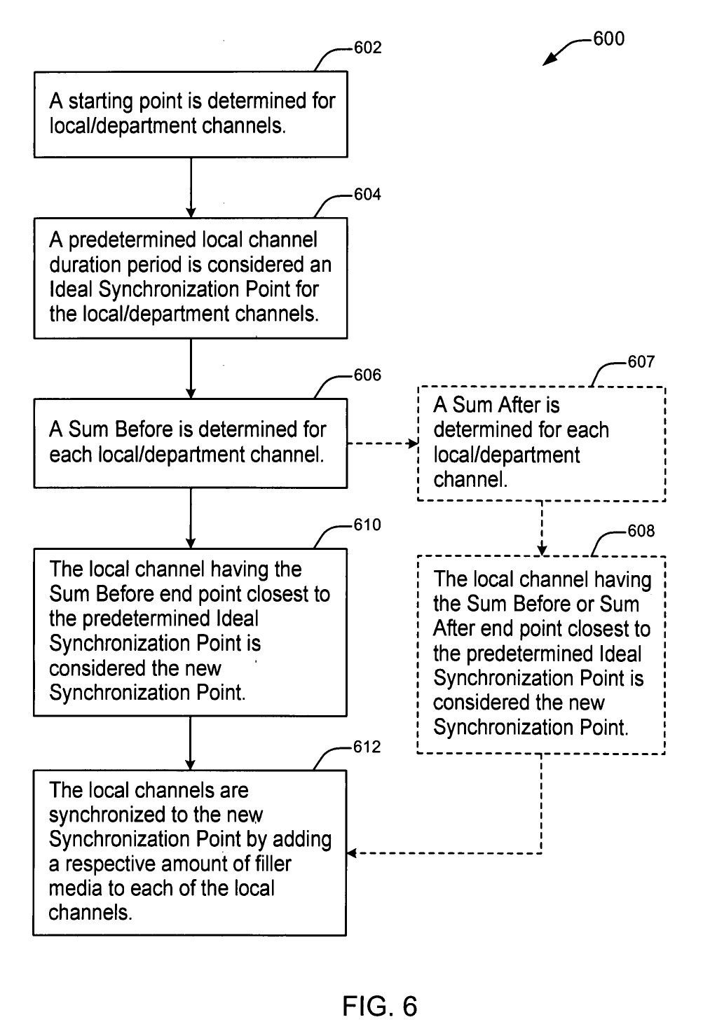

In an alternate embodiment of the present invention, the method 500 can be modified to consider the local channel having a Real Synchronization point closest to the Ideal Synchronization point as the new Synchronization point. For example, FIG. 6 depicts a flow diagram of a method for a Synchronized Playlist Calculation including the determination of a Real Synchronization Point for the transition from respective local channels to a headline channel in accordance with yet an alternate embodiment of the present invention. The method 600 begins at step 602 in which a starting point is determined or considered. That is, in various embodiments of the present invention, the starting point of the content for a local channel can be the determined Real Synchronization point for the headline channel. More specifically, when the duration of a headline channel expires, the programming of the local channels returns to displaying the respective regularly programmed content from the playlists. In alternate embodiments of the present invention, a starting point can be the initial starting point of the programming for a specific period. That is, a starting point can comprise the first run of programming for the channels. The method 600 then proceeds to step 604.

At step 604, the predetermined local channel duration period is considered as the Ideal Synchronization Point. The method 600 then proceeds to step 506.

At step 606, a Sum Before is determined for each local channel. More specifically, for each local channel a total number of media files (sequentially added from a local channel playlist) that can fit without exceeding the Ideal Synchronization Point are compiled. That is, the view for each channel is initially created with as many channel respective media files as possible, without exceeding the time until the Ideal Synchronization Point. As such, a Real Synchronization Point is determined for each channel. The method 600 then proceeds to step 610 (or optionally to step 607).

At optional step 607, a Sum After is determined for each local channel. More specifically, for each local channel a total number of media files (sequentially added from a local channel playlist) that can fit within the local channel duration period, until the first instance that the local channel duration period is exceeded by a media file, are compiled. The method 600 then proceeds to optional step 608.

At optional step 608, the local channel having Sum Before or Sum After end point closest to the predetermined Ideal Synchronization Point is considered the new Synchronization Point. The method 600 of then proceeds to step 612.

At step 610, the local channel having the Sum Before end point closest to the predetermined Ideal Synchronization Point is considered the new Synchronization Point. The method 600 then proceeds to step 610.

At step 612, the respective local channels are synchronized to the new Synchronization Point by adding a respective amount of filler media to each of the local channels, except the local channel chosen as the new Synchronization Point, to extend the media content of each of the local channels from the position of the respective Real Synchronization Points for each channel to the new Synchronization Point. That is, at step 608, the views of each channel are extended to the new Synchronization Point in order to synchronize the local channels to the local channel chosen as the new Synchronization Point. In this alternate embodiment of the present invention, it is guaranteed that at least one local channel will not require filler media.

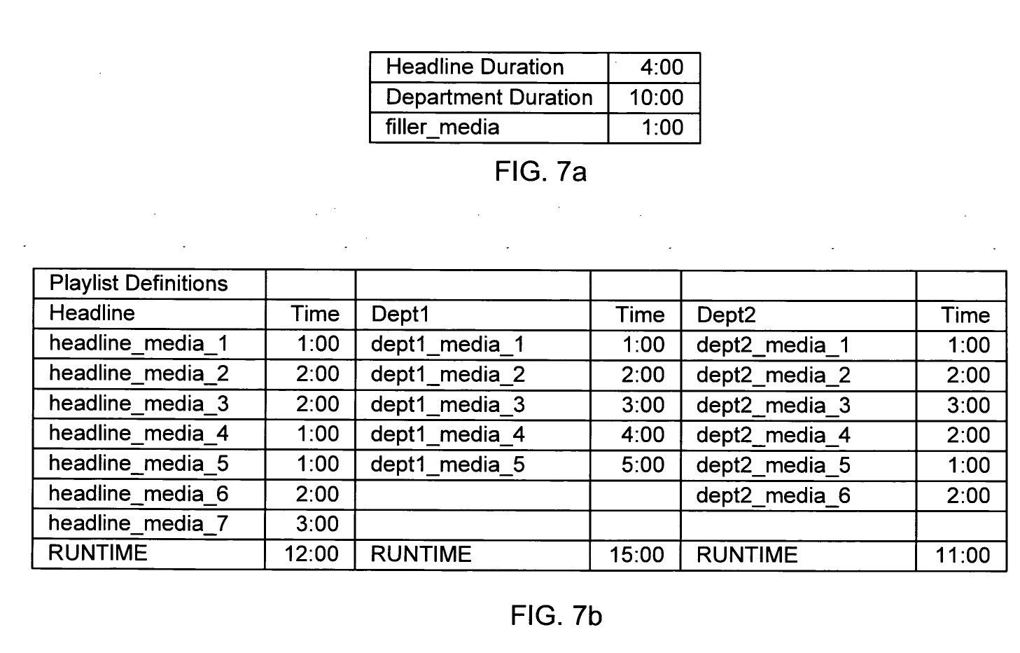

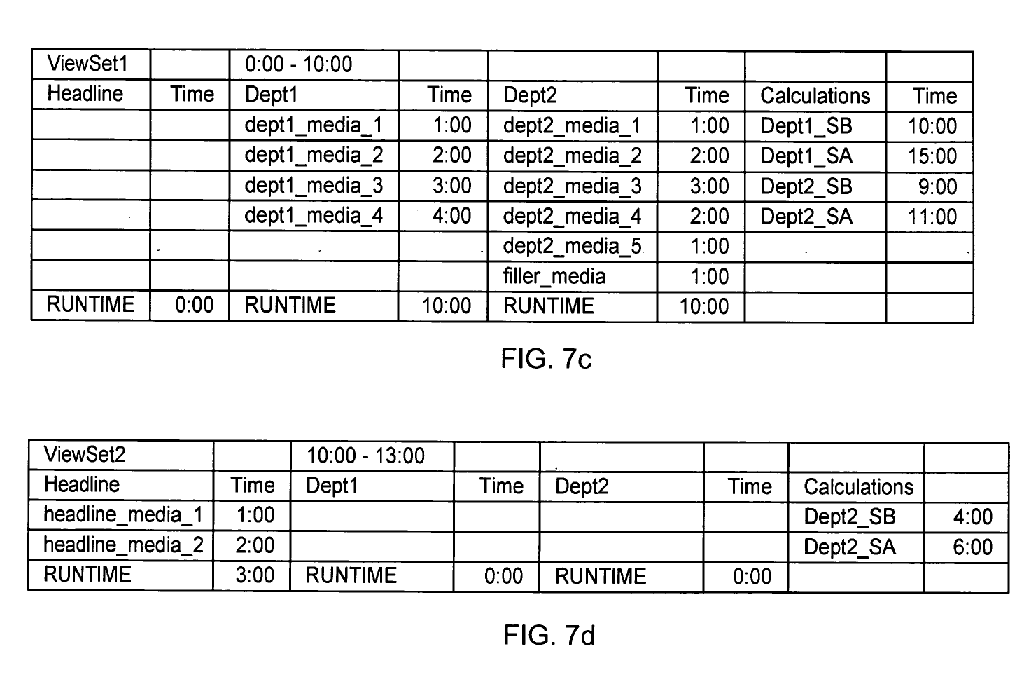

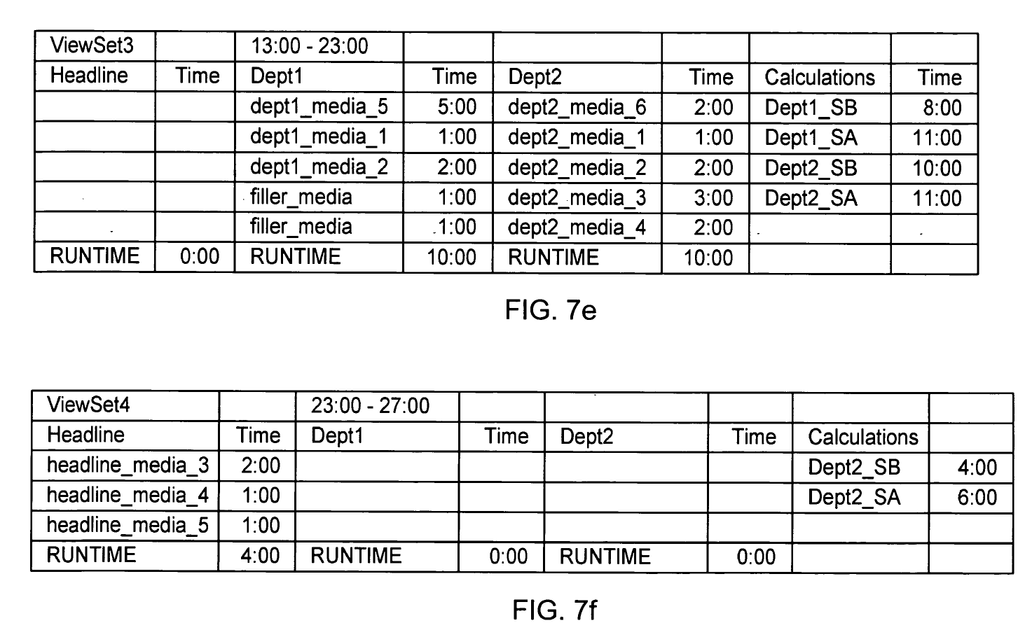

FIGS. 7a-7f depict examples of a Synchronized Playlist Calculation in accordance with an embodiment of the present invention. More specifically, FIG. 7a depicts an example of synchronization parameters for a Synchronized Playlist Calculation in accordance with an embodiment of the present invention. As depicted in FIG. 7a, a headline duration of four minutes and a local channel duration of ten minutes are defined for the Synchronized Playlist Calculation of the example of FIG. 7a. In addition, a duration of one minute has been defined for the available filler media; the filler media content being provided for synchronizing the local channels.

FIG. 7b depicts a table of channel playlist definitions for the Synchronized Playlist Calculation example of FIG. 7a in accordance with an embodiment of the present invention. For example, the Dept1 playlist includes five media files of various lengths, with a total runtime of fifteen minutes. The Dept2 playlist includes six media files of various lengths, with a total runtime of eleven minutes. In addition, and as depicted in FIG. 7b, the Headline playlist includes seven media files of various lengths, with a total runtime of twelve minutes.

FIG. 7c depicts an example of a Synchronized Playlist Calculation in accordance with an embodiment of the present invention. In the example of FIG. 7c it is assumed that the starting time for the Synchronized Playlist Calculation in accordance with the present invention starts at 0:00. As such and keeping in mind the parameters presented in FIG. 7a, Synchronized local channel playlists can be determined as depicted in FIG. 7c. More specifically, keeping in mind that the Ideal Synchronization Point (local channel duration) for the local channels is defined as ten minutes, a Real Synchronization Point is determined for channel one and channel two as described above. For channel one, the first four media clips of channel one are added to approach as close as possible to the Ideal Synchronization Point, without exceeding the Ideal Synchronization Point, to determine a Sum Before. In the example of FIG. 7c, the first four media clips of channel one actually equal the Ideal Synchronization Point of ten minutes. Subsequently, a Sum After as described above is determined for channel one. That is, by adding the fifth media clip, the Sum After for channel one is determined to be fifteen minutes.

Next, a Sum Before is determined for channel two by adding the first five media clips of channel two, which equals a total of nine minutes. Subsequently, a Sum After is determined for channel two by adding a sixth media clip for channel two, which equals a total of twelve minutes. Taking into account the Sum Before and Sum After determined for channel one and channel two, a sum that is closest to the Ideal Synchronization Point of ten minutes is selected as a Real Synchronization Point for the local channels, one and two. As depicted in FIG. 7c, the Real Synchronization point for the local channels is selected to be the Sum Before for channel one because the Sum Before for channel one is equal to the Ideal Synchronization Point, ten minutes. As such, available filler media is added to the Sum Before of channel two to cause the Sum Before value of channel two to be equal to the Real Synchronization Point for synchronizing the local channels, one and two.

FIG. 7d depicts an example of a Synchronized Playlist Calculation for a headline channel in accordance with an embodiment of the present invention. The example of the headline channel synchronization of FIG. 7d assumes that the headline channel in FIG. 7d is initiated right after the determined Real Synchronization Point for the local channels of FIG. 7d. That is, the headline channel of FIG. 7d initiates at a timeline location of ten minutes. Keeping in mind that the Ideal Synchronization Point (headline channel duration) for the headline channel is defined as three minutes, a Real Synchronization Point is determined for the headline channel as described above. More specifically, the first two media clips of the headline channel are added to approach as close as possible to the Ideal Synchronization Point, without exceeding the Ideal Synchronization Point, to determine a Sum Before. In the example of FIG. 7d, the first two media clips of the headline channel equal three minutes. Subsequently, a Sum After as described above is determined for the headline channel. That is, by adding the third media clip, the Sum After for the headline channel is determined to be five minutes. In the example of FIG. 7d, although the Sum Before and the Sum After of the headline channel have equal delta to the Ideal Synchronization Point, the Sum Before is selected as the Real Synchronization Point. As such, the first two media clips of the headline channel are displayed during the headline duration, at which point at a time of thirteen minutes, the headline channel expires. The view then transitions back to the respective local channels.

More specifically, FIG. 7e depicts an example of a Synchronized Playlist Calculation for a second transition to local channels in accordance with an embodiment of the present invention. FIG. 7e illustrates the display of local channels between a time of thirteen minutes until a time of twenty-three minutes. Again, keeping in mind that the Ideal Synchronization Point (local channel duration) for the local channels is defined as ten minutes, a Real Synchronization Point is determined for channel one and channel two as described above.

For channel one, the compilation of the media clips of channel begin with media clip number five, because the last media clip used in the previous presentation of the media clips of channel one was number four. As such, beginning with media clip number five, the media clips of channel one are added one by one to approach as close as possible to the Ideal Synchronization Point, without exceeding the Ideal Synchronization Point, to determine a Sum Before. In the example of FIG. 7e, beginning with media clip number five, media clips number five, one and two of channel one are compiled to equal a total time of eight minutes. Subsequently, a Sum After as described above is determined for channel one. That is, by adding the third media clip, the Sum After for channel one is determined to be eleven minutes.

Next, a Sum Before is determined for channel two by adding media clip numbers six, one, two, three and four of channel two, which equals a total of ten minutes. Again, channel two begins with media clip number six because the last media clip used in the previous presentation of the media clips of channel two was number five. Subsequently, a Sum After is determined for channel two by adding media clip number five for channel two, which equals a total of eleven minutes. Taking into account the Sum Before and Sum After determined for channel one and channel two, a compilation of media clips that is closest to the Ideal Synchronization Point of ten minutes is selected as a Real Synchronization Point for the local channels, one and two. As depicted in FIG. 7e, the Real Synchronization point for the local channels is selected to be the Sum Before for channel two because the Sum Before for channel two is equal to the Ideal Synchronization Point, ten minutes. As such, available filler media equal to two minutes is added to the Sum Before of channel one to cause the Sum Before value of channel one to be equal to the Real Synchronization Point of ten minutes for synchronizing the local channels, one and two.

FIG. 7f depicts an example of a Synchronized Playlist Calculation for a second transition to a headline channel in accordance with an embodiment of the present invention. That is, FIG. 7f illustrates the display of local channels between a time of twenty-three minutes until a time of twenty-seven minutes. Again, keeping in mind that the Ideal Synchronization Point (headline channel duration) for the headline channel is defined as four minutes, a Real Synchronization Point is determined for the headline channel as described above.

More specifically, in FIG. 7f the compilation of the media clips for determining a Sum Before and Sum After for the headline channel begins with headline media clip number three because the last media clip used in the previous presentation of the media clips of the headline channel was media clip number two. As such, beginning with media clip number three, the media clips of the headline channel are added one by one to approach as close as possible to the Ideal Synchronization Point, without exceeding the Ideal Synchronization Point, to determine a Sum Before. In the example of FIG. 7f, beginning with media clip number three, media clips number three, four and five of the headline channel are compiled to equal a total time of four minutes. Subsequently, a Sum After as described above is determined for the headline channel. That is, by adding the sixth media clip, the Sum After for the headline channel is determined to be six minutes.

Taking into account the Sum Before and Sum After determined for the headline channel, a compilation of media clips that is closest to the Ideal Synchronization Point of four minutes is selected as a Real Synchronization Point for the headline channel. As depicted in FIG. 7f, the Real Synchronization point for the headline channel is selected to be the Sum Before for the headline channel because the Sum Before for the headline channel is equal to the Ideal Synchronization Point, four minutes. After the expiration of the headline duration, the system view then transitions back to the respective local channels.

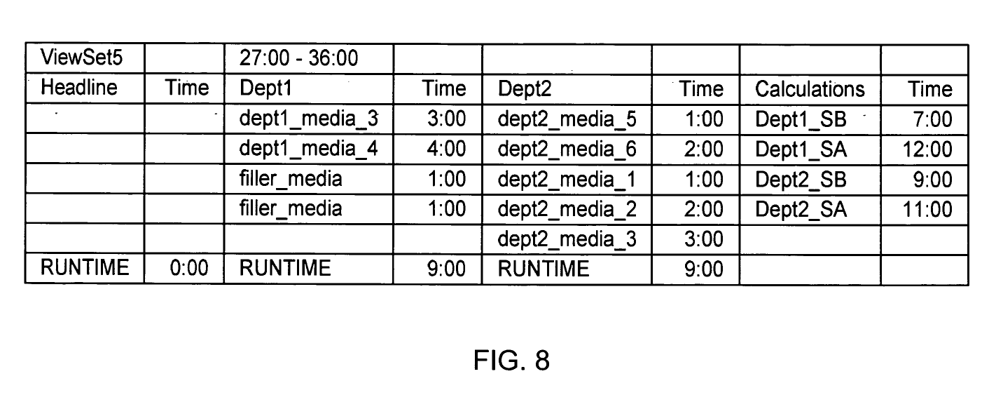

FIG. 8 depicts an example of a Synchronized Playlist Calculation for local channels in accordance with an alternate embodiment of the present invention. In the example of FIG. 8, a playlist duration or compilation time of a local channel having a time closest to an Ideal Synchronization Point is selected as a Real Synchronization Point for all of the local channels. More specifically, the example of FIG. 8 begins at a time of twenty-seven minutes following the displays of FIGS. 7a-7f as described above and specifically following the headline channel display of FIG. 6f. In the example of FIG. 8, keeping in mind that the Ideal Synchronization Point (local channel duration) for the local channels is defined as ten minutes, a Real Synchronization Point is determined for channel one and channel two as described above.

For channel one, the compilation of the media clips of channel one begin with media clip number three, because the last media clip used in the previous presentation of the media clips of channel one was number two. As such, beginning with media clip number three, the media clips of channel one are added one by one to approach as close as possible to the Ideal Synchronization Point, without exceeding the Ideal Synchronization Point, to determine a Sum Before. In the example of FIG. 8, beginning with media clip number three, media clips number three and four of channel one are compiled to equal a total time of seven minutes. Subsequently, a Sum After as described above is determined for channel one. That is, by adding the fifth media clip, the Sum After for channel one is determined to be twelve minutes.

Next, a Sum Before is determined for channel two by adding media clip numbers five, six, one, two and three of channel two, which equals a total of nine minutes. Again, channel two begins with media clip number five because the last media clip used in the previous presentation of the media clips of channel two was number four. Subsequently, a Sum After is determined for channel two by adding media clip number four for channel two, which equals a total of eleven minutes. Taking into account the Sum Before and Sum After determined for channel one and channel two, a compilation of media clips that is closest to the Ideal Synchronization Point of ten minutes is selected as a Real Synchronization Point for the local channels, one and two. As depicted in FIG. 8, the Real Synchronization point for the local channels is selected to be the Sum Before for channel two because the Sum Before of nine minutes for channel two is closest in time to the Ideal Synchronization Point, ten minutes. As such, available filler media equal to two minutes is added to the Sum Before of channel one to cause the Sum Before value of channel one to be equal to the Real Synchronization Point of nine minutes for synchronizing the local channels, one and two.

Although in various embodiments of the present invention described herein filler media is described as being added to the end of a playlist, in accordance with the present invention, filler media can be added to the beginning, the end or anywhere within a playlist to synchronize playlists in accordance with the concepts of the present invention.

Having described various embodiments for a method, apparatus and system providing improved transitions between alternating individual channel programming and common channel programming using synchronized playlists (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for individual channel playlists synchronization, comprising:
compiling respective content portions for individual channels to cause endpoints of the respective playlists of said individual channels to attempt to reach a desired synchronization point;
selecting the endpoint of an individual channel playlist compilation as an actual synchronization point for the respective individual channel playlists; and
adding respective filler content portions to the individual channel playlist compilations to cause the respective playlists of said individual channels to end at said actual synchronization point.

2. The method of claim 1, wherein said desired synchronization point is equal to the endpoint of an individual channel playlist compilation.

3. The method of claim 1, wherein said actual synchronization point is a point in time before said desired synchronization point.

4. The method of claim 1, wherein said actual synchronization point is a point in time after said desired synchronization point.

5. The method of claim 1, wherein said content portions comprise media clips.

6. The method of claim 5, wherein said media clips comprise advertising media content.

7. The method of claim 1, wherein the endpoint of an individual channel playlist compilation closest to said desired synchronization point is selected as said actual synchronization point.

8. The method of claim 1, wherein said desired synchronization point comprises a desired individual channel playlist duration.

9. A method for common channel playlist synchronization, comprising:
compiling content portions of a common channel to cause an endpoint of the playlist compilation of said common channel to attempt to reach a desired synchronization point; and
selecting as a length for the playlist of said common channel a compilation of said content portions that ends at a point closest to said desired synchronization point.

10. The method of claim 9, wherein said desired synchronization point comprises a desired common channel playlist duration.

11. The method of claim 9, wherein said content portions comprise media clips.

12. The method of claim 11, wherein said media clips comprise advertising media content.

13. A method for synchronizing alternating individual and common channel playlists, comprising:
for individual channels, compiling respective content portions for individual channels to cause endpoints of the respective playlists of said individual channels to attempt to reach a desired synchronization point for the playlists of said individual channels;
selecting the endpoint of an individual channel playlist compilation as an actual synchronization point for the playlists of said individual channels; and
adding respective filler content portions to the individual channel playlist compilations to cause the respective playlists of said individual channels to end at said actual synchronization point;
for a subsequent common channel,
starting said common channel playlist at the actual synchronization point for the playlists of said individual channels;
compiling content portions of said common channel to cause an endpoint of the playlist compilation of said common channel to attempt to reach a desired synchronization point for the playlist of said common channel; and
selecting as a length for the playlist of said common channel a compilation of said content portions that ends at a point closest to said desired synchronization point for the playlist of said common channel; and
for subsequent individual channels, starting said individual channel playlists at the selected actual synchronization point of said common channel playlist.

14. The method of claim 13, wherein said desired synchronization point is equal to the endpoint of an individual channel playlist compilation.

15. The method of claim 13, wherein said actual synchronization point is a point in time before said desired synchronization point.

16. The method of claim 13, wherein said actual synchronization point is a point in time after said desired synchronization point.

17. The method of claim 13, wherein said content portions comprise media clips.

18. The method of claim 17, wherein said media clips comprise advertising media content.

19. The method of claim 13, wherein the endpoint of an individual channel playlist compilation closest to said desired synchronization point is selected as said actual synchronization point.

20. The method of claim 13, wherein said desired synchronization point comprises a desired individual channel playlist duration.

21. A system for synchronizing respective individual channel playlists and a common channel playlist, comprising:
at least one content source for providing individual channel content, filler content and at least one common channel content; and
a controller including a memory for storing at least information regarding the individual channel content, filler content, common channel content and program instructions, and a processor for executing said program instructions, the controller adapted to perform the steps of;
for individual channels, compiling respective content portions for individual channels to cause endpoints of the respective playlists of said individual channels to attempt to reach a desired synchronization point for the playlists of said individual channels;
selecting the endpoint of an individual channel playlist compilation as an actual synchronization point for the playlists of said individual channels; and
adding respective filler content portions to the individual channel playlist compilations to cause the respective playlists of said individual channels to end at said actual synchronization point;
for a subsequent common channel, starting said common channel playlist at the actual synchronization point for the playlists of said individual channels;
compiling content portions of said common channel to cause an endpoint of the playlist compilation of said common channel to attempt to reach a desired synchronization point for the playlist of said common channel; and
selecting as a length for the playlist of said common channel a compilation of said content portions that ends at a point closest to said desired synchronization point for the playlist of said common channel; and
for subsequent individual channels, starting said individual channel playlists at the selected actual synchronization point of said common channel playlist.

22. The system of claim 21, wherein said at least one content source comprises at least one of an advertiser, a recording company and a movie studio.

23. The system of claim 21, wherein said controller comprises a server of at least one of a network management center, a network operations center and a content distribution network.
